(19) United States
(12) Patent Application Publication
(10) Pub. No.: US 2025/0383510 A1
(43) Pub. Date: Dec. 18, 2025

(54) OPTICAL FIBER CONNECTOR DUST CAP WITH IMPROVED CONNECTOR INTERFACE

(71) Applicant: CommScope Technologies LLC, Hickory, NC (US)

(72) Inventors: Connor Thomas WILSON, Maple Grove, MN (US); Carl B. LUNDBORG, Belle Plaine, MN (US); Steven Conrad ZIMMEL, Minneapolis, MN (US)

(73) Assignee: CommScope Technologies LLC, Hickory, NC (US)

(21) Appl. No.: 18/876,066

(22) PCT Filed: Jun. 12, 2023
(86) PCT No.: PCT/US2023/068285

§ 371 Date: Dec. 17, 2024

Related U.S. Application Data
(60) Provisional application No. 63/366,557, filed on Jun. 17, 2022.

(51) Int. Cl. G02B 6/38

(52) U.S. Cl. CPC G02B 6/3849; G02B 6/3885

(57) ABSTRACT

A dust cap for capping an optical fiber connector. In another embodiment, an assembly including an optical fiber connector subassembly and a dust cap. The dust cap includes structural features that can optimize one or more aspects of the dust cap, such as case of use, robustness, and the dust cap's ability to inhibit ingress of contaminants that can damage ends of optical fibers within the dust cap.

### CROSS-REFERENCE TO RELATED APPLICATIONS

This application is being filed on Jun. 12, 2023, as a PCT International application and claims the benefit of and priority to U.S. Provisional Application No. 63/366,557, filed on Jun. 17, 2022, the disclosure of which is hereby incorporated by reference in its entirety.

### TECHNICAL FIELD

The present disclosure relates to fiber optic data transmission and more particularly to optical fibers and optical fiber connection systems and the installation thereof.

### BACKGROUND

As demand for telecommunications increases, optical fiber services are being extended in more and more areas. In order for a residence or business to access these optical fiber services, optical fibers must be installed in these residences and businesses. In some cases, the optical fibers are installed in existing structures. In other cases, these optical fibers are installed in new constructions.

To facilitate installation and connection to various telecommunications equipment, the optical fibers are often connectorized. In particular, one or both ends of the optical fiber may include a fiber optic connector. The fiber optic connector may connect to various telecommunications equipment, including other optical fibers. The fiber optic connector may support and position ends of optical fibers (e.g., within a ferule of the fiber optic connector). The ends of the optical fibers may abut ends of other optical fibers and thereby form an optical connection from fiber to fiber.

Prior to connection (e.g., during installation) and during periods of disconnection (e.g., during maintenance, reconfiguration, etc.), the ends of the optical fibers may be exposed. Exposure of the ends of the optical fibers is undesired as they may be subjected to contamination and/or damage. Caps (e.g., dust caps) may be fitted over the ends of the optical fibers by placing the caps over the end of the fiber optic connector. The ends of the optical fibers and/or the end of the fiber optic connector may thereby be protected from contamination and/or damage.

During installation and/or reconfiguration, the optical fibers may be routed through small and/or enclosed spaces, such as between support structures disposed inside walls, or through ducts. The ducts can be within a building, aerially suspended, buried underground, etc. In order to convey the optical fibers through these enclosed spaces, cable pullers or other forms of conveyance (such as blowing devices or other pushing mechanisms) can be used.

### SUMMARY

In general terms, the present disclosure is directed to a dust cap for an optical fiber connector, such as a multi-fiber connector.

In further general terms, the present disclosure is directed to an assembly of a dust cap and an optical fiber connector, wherein the dust cap is removably installed on the connector and/or is configured to be installed on and removed from the connector.

The dust cap covers the end of the optical fiber connector and can inhibit or prevent ingress of contaminants, such as dust or moisture, that could negatively impact the exposed ends of the optical fibers terminated at the connector.

In some examples, the dust cap can form a seal at the connector to inhibit or prevent ingress of contaminants. In some examples, the seal can be a hermetic seal.

The dust cap is configured for easy installation of the dust cap on the connector and easy removal of the dust cap, while providing a strong coupling interface with the connector when the dust cap is installed.

The dust cap includes structural features that can, e.g., optimize usability of the dust cap, for example, by maximizing protection against ingress of contaminants during typical operations when the dust cap is installed on the connector including securing the dust cap against inadvertent removal thereof from the connector, while minimizing the amount of force needed to install the dust cap on the connector and/or to remove the dust cap from the connector.

The dust cap is configured to be installed on a connector by a snap-fit connection.

In some examples, the dust cap is constructed of a polymeric material.

In some examples, structural aspects of the dust cap enhance the ability of the dust cap to be molded of a molded polymeric material.

In some examples, an assembly of a dust cap and a connector is configured to be conveyed through a duct. Conveyance of the assembly through a duct can achieved by pulling the assembly (e.g., with a wire or string), or pushing the assembly. An example of pushing the assembly through the duct includes blowing the assembly through the duct. e.g., with compressed air or another fluid.

The dust cap can be removed from the assembly and the connector can then be installed on telecommunications equipment to provide active or passive optical connectivity via the fibers terminated at the connector. Such telecommunications equipment can include an organizer of a telecommunications closure, a panel, a cabinet, a tray, and so forth. The connector can be optically connected to another connector at the telecommunications equipment to provide an active optical connection, or parked at the telecommunications equipment until a later time when an active optical connection is needed. In some examples, the dust cap can remain on the connector while it is parked. In other examples, the dust cap is removed for parking of the connector.

The connector assemblies shown and described herein include multi-fiber connectors, e.g., MPO-type connectors, that include ferrules that terminate multiple fibers (e.g., 8 or 12 fibers in one row of fibers or 24 fibers in two rows of fibers). The end face of the ferrule is configured to abut the end face of another ferrule to provide an optical connection between the fibers at the connectors' ferrule faces.

Principles of the present disclosure can be applied to other types of connector-dust cap assemblies, such as assemblies where the connector (e.g., a LC-type connector or a SC-type connector) terminates a single fiber, or a pair of fibers.

In some examples, the fibers terminated at the connector are ribbonized, in that they form an optical fiber ribbon. The ribbon can be a flat ribbon or a rollable ribbon.

In some examples, the connector of a connector-dust cap assembly according to the present disclosure includes a ferrule, such as a MPO ferrule. In other examples, the connector can be ferrule-less.

The connector of a connector-dust cap assembly according to the present disclosure can be installed in an optical fiber adapter, e.g., in a patch panel, to establish optical connectivity with one or more fibers of another connector installed in the same adapter.

According to certain specific aspects, the present disclosure is directed to a dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap including: a cap body defining a cap interior and a cap exterior, the cap body having an open back end and a closed front end, the cap body being configured to receive a portion of the connector in the cap interior through the open back end; and a latch at at least one of the left side and the right side of the dust cap, wherein the latch is configured to lockingly engage the connector when the connector is received in the cap interior, and wherein the dust cap is asymmetrical about a plane defined by the first axis and the second axis.

According to further specific aspects, the present disclosure is directed to a dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap including: a cap body defining a cap interior and a cap exterior, the cap body having an open back end and a closed front end, the cap body being configured to receive a portion of the connector in the cap interior through the open back end, the cap body including a top wall and a bottom wall; and a latch at at least one of the left side and the right side of the dust cap, wherein a first portion of the top wall extends further back than a second portion of the top wall.

According to further specific aspects, the present disclosure is directed to a dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap including: a cap body defining a cap interior and a cap exterior, the cap body having an open back end and a closed front end, the cap body being configured to receive a portion of the connector in the cap interior through the open back end, wherein the dust cap includes only one latch configured to latch the dust cap to the optical fiber connector when the optical fiber connector is received in the cap interior.

According to further specific aspects, the present disclosure is directed to a dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap including: a cap body defining a cap interior and a cap exterior, the cap body having an open back end and a closed front end, the cap body being configured to receive a portion of the connector in the cap interior through the open back end; and a latch at each of the left side and the right side of the dust cap, wherein each latch is configured to lockingly engage the connector when the connector is received in the cap interior, and wherein each latch is associated with exactly one material void in the cap body configured to facilitate flexing of the latch.

According to further specific aspects, the present disclosure is directed to an assembly, including: a fiber optic connector subassembly, including: a ferrule: optical fibers terminated at the ferrule: an inner connector body that receives the ferrule: an outer connector body that slides relative to the inner body parallel to a first axis: a spring seat positioned in the inner connector body; and a spring positioned in the inner connector body, the spring being compressed between the spring seat and the ferrule and biasing the ferrule along the first axis; and a dust cap installed on the subassembly, the dust cap extending from a front end to a back end along the first axis, the dust cap extending from a top to a bottom along a second axis, the dust cap extending from a left side to a right side along a third axis, the first axis, the second axis and the third axis being mutually perpendicular to one another, the dust cap including: a cap body defining a cap interior and a cap exterior, the cap body having an open back end and a closed front end, the cap body receiving a portion of the inner connector body in the cap interior, and a latch at at least one of the left side and the right side of the dust cap, the latch latching to a shoulder defined by the inner connector body, wherein the dust cap is asymmetrical about a plane defined by the first axis and the second axis.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a perspective view of an example assembly of a connector and a dust cap according to the present disclosure, and including a set of schematically represented optical fibers terminated at the connector.

FIG. 2 is a further perspective view of the assembly of FIG. 1.

FIG. 3 is a partially exploded view of the connector assembly of FIG. 1.

FIG. 4 is a further partially exploded view of the connector assembly of FIG. 1.

FIG. 5 is a cross-sectional view of the assembly of FIG. 1.

FIG. 6 is an enlarged, perspective view of a portion of the assembly as shown in FIG. 5.

FIG. 7 is a further cross-sectional view of the assembly of FIG. 1.

FIG. 8 is a perspective view of the dust cap of the assembly of FIG. 1.

FIG. 9 is a further perspective view of the dust cap of FIG. 8.

FIG. 10 is a top planar view of the dust cap of FIG. 8.

FIG. 11 is a bottom planar view of the dust cap of FIG. 8.

FIG. 12 is a back end planar view of the dust cap of FIG. 8.

FIG. 13 is a front end planar view of the dust cap of FIG. 8.

FIG. 14 is a left side planar view of the dust cap of FIG. 8.

FIG. 15 is a right side planar view of the dust cap of FIG. 8.

FIG. 16 is a perspective, cross-sectional view of the dust cap of FIG. 8, showing the left half of the dust cap of FIG. 8.

FIG. 17 is a perspective, cross-sectional view of the dust cap of FIG. 8, showing the right half of the dust cap of FIG. 8.

FIG. 18 is a perspective view of a further example assembly of a connector and a dust cap according to the present disclosure.

FIG. 19 is an exploded view of the assembly of FIG. 18.

FIG. 20 is a cross-sectional view of the assembly of FIG. 18.

FIG. 21 is a further cross-sectional view of the assembly of FIG. 18.

FIG. 22 is a perspective view of the dust cap of the assembly of FIG. 18.

FIG. 23 is a further perspective view of the dust cap of FIG. 22.

FIG. 24 is a perspective view of a further example assembly of a connector and a dust cap according to the present disclosure.

FIG. 25 is an exploded view of the assembly of FIG. 24.

FIG. 26 is a cross-sectional view of the assembly of FIG. 24.

FIG. 27 is a further cross-sectional view of the assembly of FIG. 24.

FIG. 28 is a perspective view of the dust cap of the assembly of FIG. 24.

FIG. 29 is a further perspective view of the dust cap of FIG. 28.

### DETAILED DESCRIPTION

The present disclosure is directed to dust caps and corresponding fiber optic connectors and cable assemblies. The same cap may serve as both a dust cap and a pulling cap. The dust cap/pulling cap can cover a front end of the corresponding fiber optic connector assembly.

As used herein, terms such as front, back, rear, forward, up, down, above, below, left, right, horizontal, vertical, proximal, distal, and so forth are for ease of description in relating positions of components or portions of components in assemblies. These terms do not limit how features or components of assemblies of the present disclosure may be situated in practice.

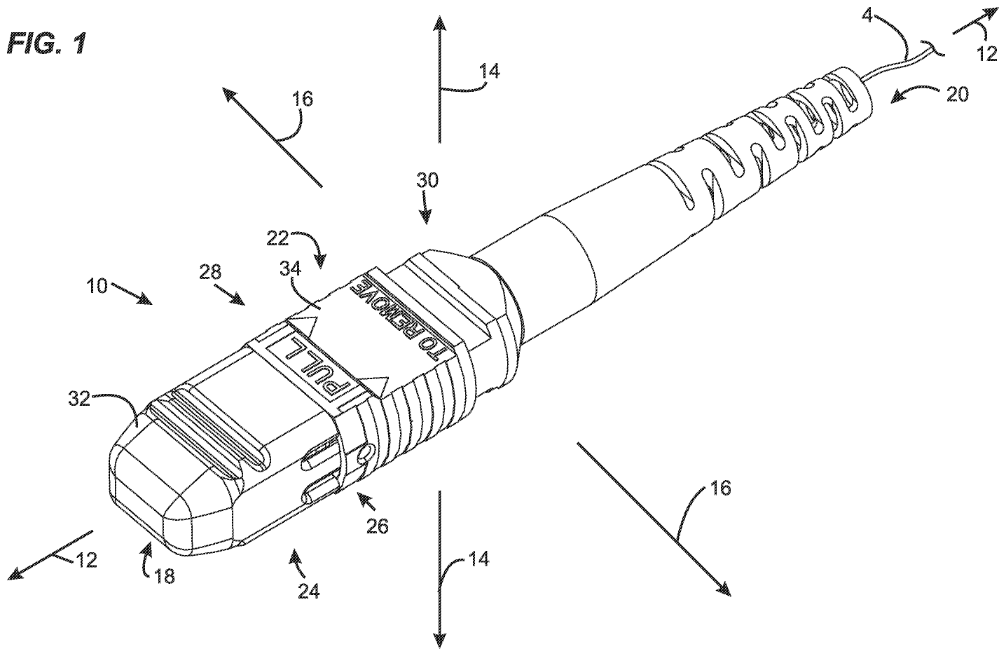

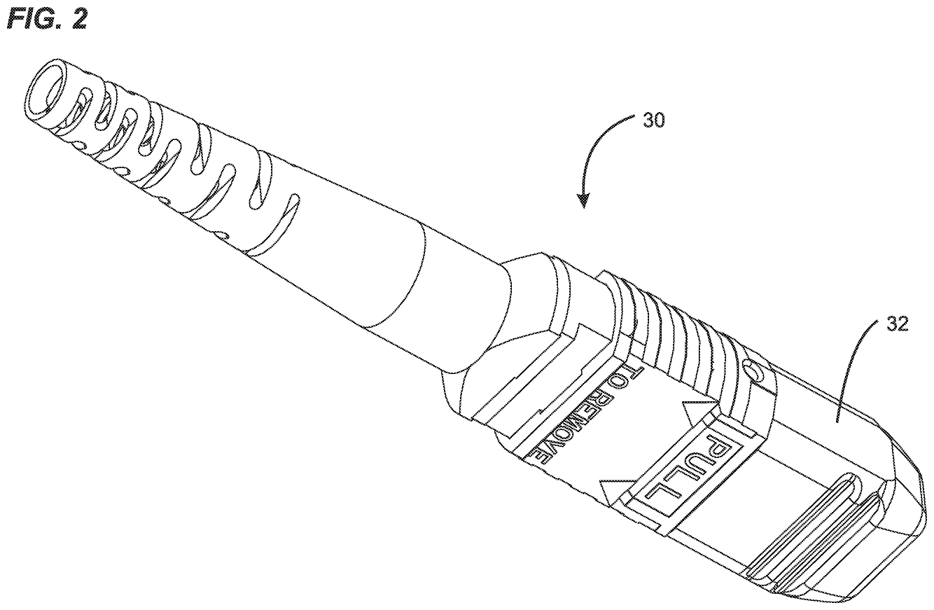

Referring to FIGS. 1-2, an assembly 10 in accordance with the present disclosure is shown. The assembly 10 extends along a first axis 12 from a front end 18 to a back end 20. The assembly 10 extends a long a second axis 14 from a top 22 to a bottom 25. The assembly 10 extends along a third axis 16 from a left side 26 to a left right 28.

The assembly 10 includes an optical fiber connector subassembly 30 and a dust cap 32 installed on the subassembly 30. The dust cap 32 is latched (e.g., lockingly engaged to) to a portion of the subassembly 30.

In FIG. 1, one or more optical fibers 4 extend through the subassembly 30 and are terminated at a ferrule of the subassembly 30. The dust cap 32 protects the exposed ends of the one or more optical fibers 4 at the end face of the ferrule, from contaminants such as dust or moisture.

The assembly 10 can be conveyed through spaces with small clearance, such as ducts. For example, the assembly 10 can be pulled (e.g., with a tow rope, a wire, a string) through a duct or pushed (e.g., blown) through a duct, in order to transport the one or more optical fibers 4 to desired telecommunications equipment, such as a closure, a cabinet, a patch panel, etc. Once at the desired equipment, the dust cap 32 can be removed to expose the ends of the fiber(s) 4 at the end face of the ferrule, and the connector of the subassembly 30 can be installed in an adapter to provide an optical connection to optical fibers terminated at another connector. Alternatively, the connector, with or without the dust cap 32 removed, can be installed in a parking location at the telecommunications equipment, for possible future active connections.

The dust cap 32 can also protect the fiber(s) 4 whenever the dust cap 32 is installed on the subassembly 30, such as during storage, shipment, or other handling of the assembly 10.

In the example shown, the subassembly 30 includes a MPO-type connector. However, principles of the dust caps of the present disclosure can be applied to other types of optical fiber connectors, such as SC-type connectors and LC-type connectors.

The dust cap 32 latches to a body of the subassembly 30. The latching is sufficiently strong to substantially inhibit or prevent unintentional removal of the dust cap 32 from the subassembly 30, such as in shipment of the assembly 10, or while the assembly 10 is being conveyed through a duct.

In some examples, the latching configuration is such that the dust cap 32 can be de-latched and removed from the subassembly 30 by pulling it forwards (along the axis 12) while simply holding a portion of the subassembly 30. In other examples, due to a contact interface between the latch of the dust cap 32 and the outer connector body, or sleeve. 34 of the subassembly 30, the latching configuration is such that the dust cap 32 can be de-latched and removed from the subassembly 30 only by first sliding the outer connector body 34 of the subassembly 30 rearwards, and while the outer connector body 34 is slid rearward, pulling forward on the dust cap 32 to remove it from the subassembly 30.

The subassembly 30 includes a boot 36, a crimp 38, a spring seat 40, an inner connector body 42, the outer connector body 34, a spring 44, and a ferrule 46. Optionally, the subassembly 30 includes a fiber guide 50. If the connector is a male connector, the subassembly 30 can include a piece 48 that includes pins for mating with pin holes of a female connector.

The optical fiber(s) 4 is/are terminated at the end face 52 of the ferrule 46. The ferrule 46 is positioned within the inner connector body 42 and at a forward end of the inner connector body 42. The ferrule 46 is biased forwards by the spring 44. The spring is captured by the ferrule 46 or the guide 50 at the front end of the spring, and by the spring seat 40 at the back end of the spring. The spring seat 40 is received within the inner connector body 42 rearward of the ferrule 46. The crimp 38 is secured to a rear end portion of the spring seat 40. The crimp 38 can be crimped around a jacket or a tube of a cable carrying the optical fiber(s) 4 to fix the cable to the subassembly. The boot 36 can be sleeved over and secured to (e.g., by friction fit) the crimp 38. The boot 36 is a flexible bend radius limiter and is configured to protect against over bending of the cable, which can damage the optical fiber(s) 4 and/or negatively impact signal transmission via the optical fiber(s) 4.

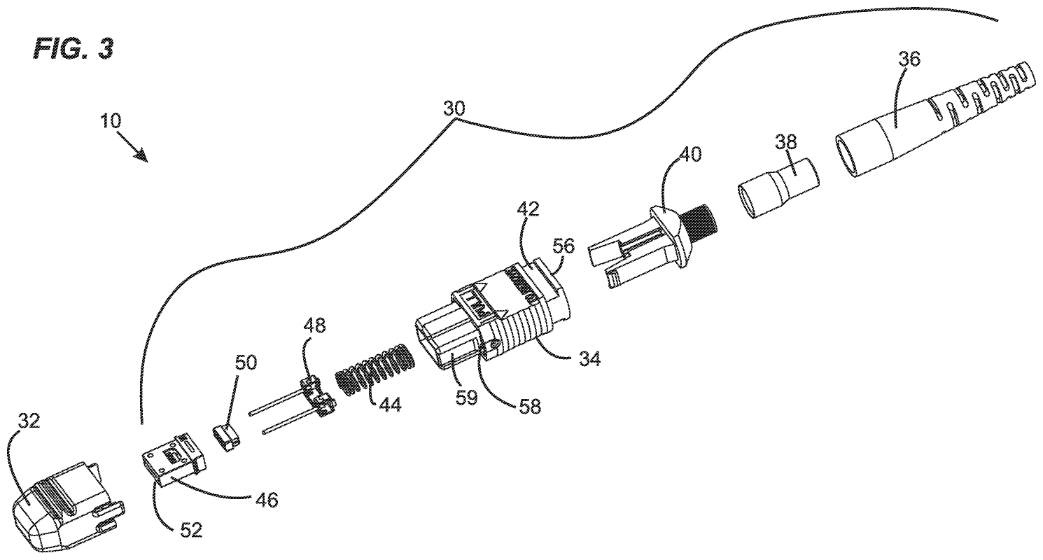

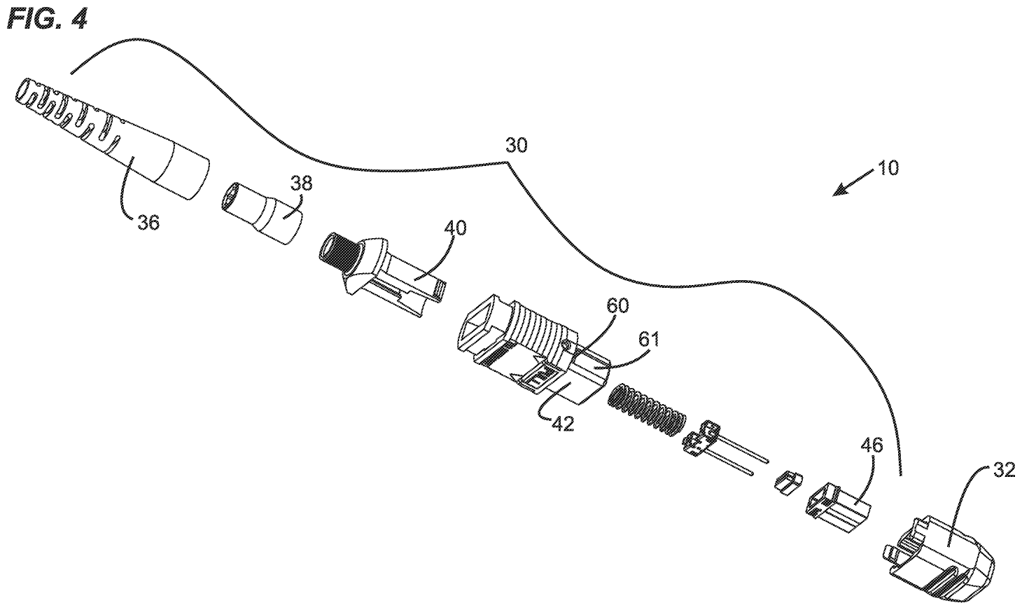

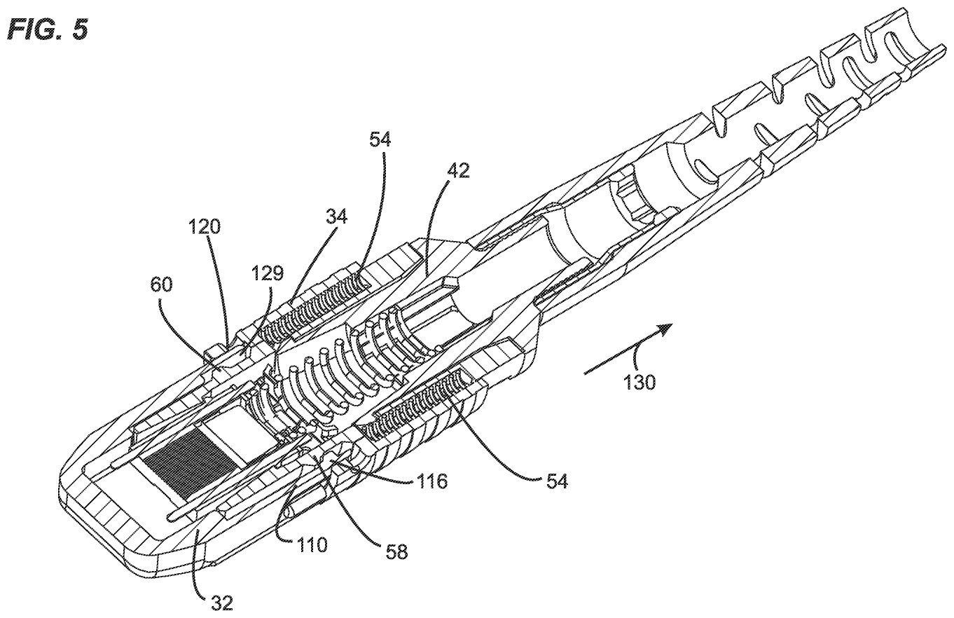

The outer connector body or sleeve 34 surrounds an exterior of the inner connector body. The sleeve 34 is spring loaded, with one or more springs 54 (FIG. 5) biasing the sleeve 34 forwards to its forward position, which is the position of the sleeve shown, for example, in FIG. 1. The sleeve 34 can be slid rearwards against the action of the springs 54 to a rear position in which the sleeve 34 abuts a protruding shoulder 56 of the inner connector body 42 (FIG. 3).

The inner connector body 42 includes a left shoulder 58 within a left recess 59, and a right shoulder 60 within a right recess 61, of the inner connector body 42. Latches, e.g., of an optical fiber adapter can lockingly engage the shoulders 58 and 60, with the catches of the latches riding rearwardly over the shoulders 58 and 60 snapping inward to latched engagement with the shoulders 58 and 60 immediately behind the shoulders 58 and 60. In some examples, the latches of the adapter engage and push the sleeve 34 rearward in order to latch to the shoulders 58 and 60. Once latched, there is enough clearance for the sleeve 34 to return to its forward position, covering portions of the latches and preventing or inhibiting disconnection of the connector from the adapter. To remove the connector from the adapter, the sleeve 34 is grasped (e.g., by hand) and pulled rearwards so that when the connector is pulled rearwards away from the adapter, the latches of the adapter can ride forwardly over the shoulders 58 and 60 and the connector can be freed from the adapter.

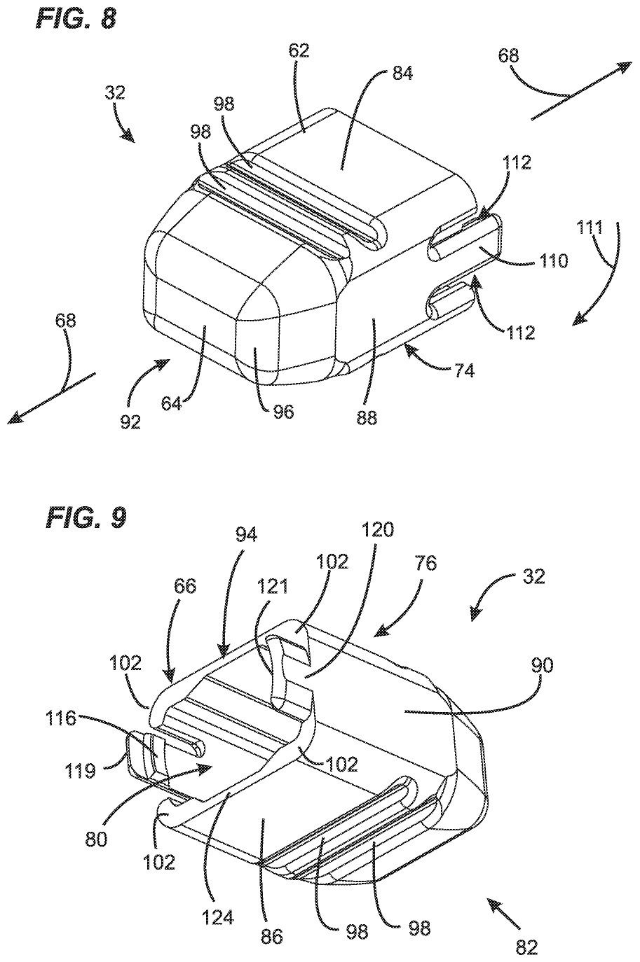

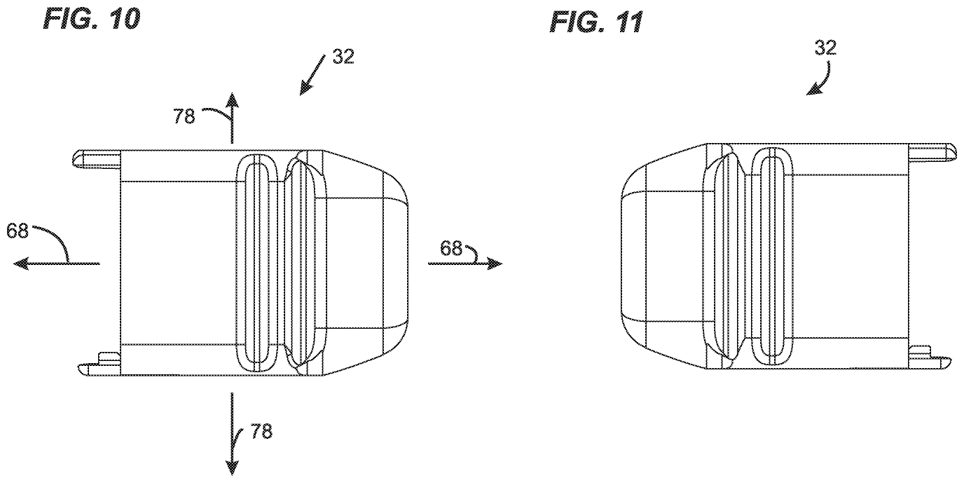

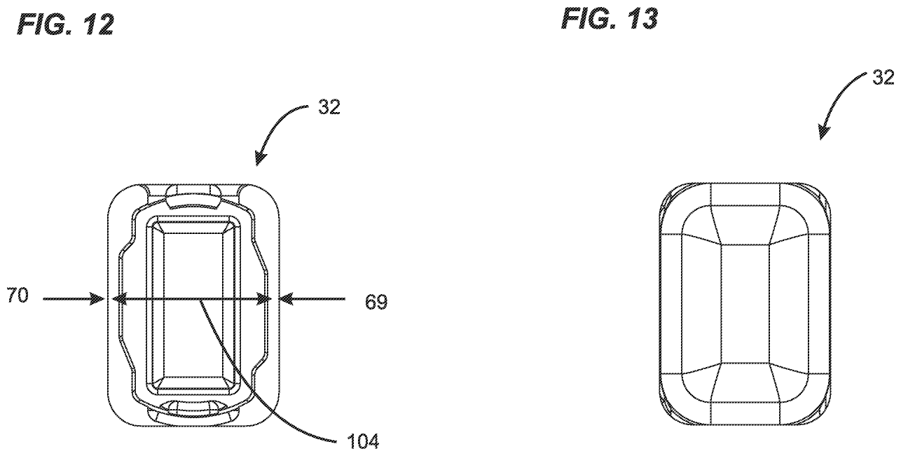

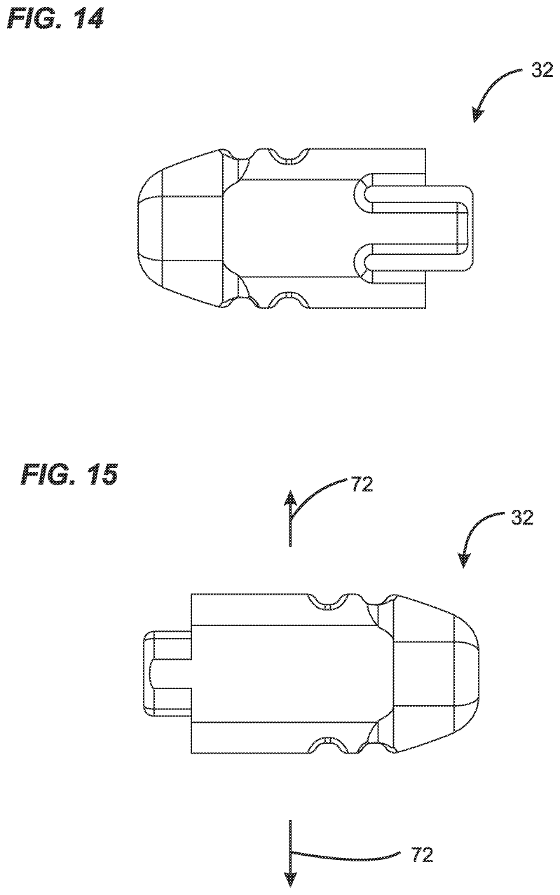

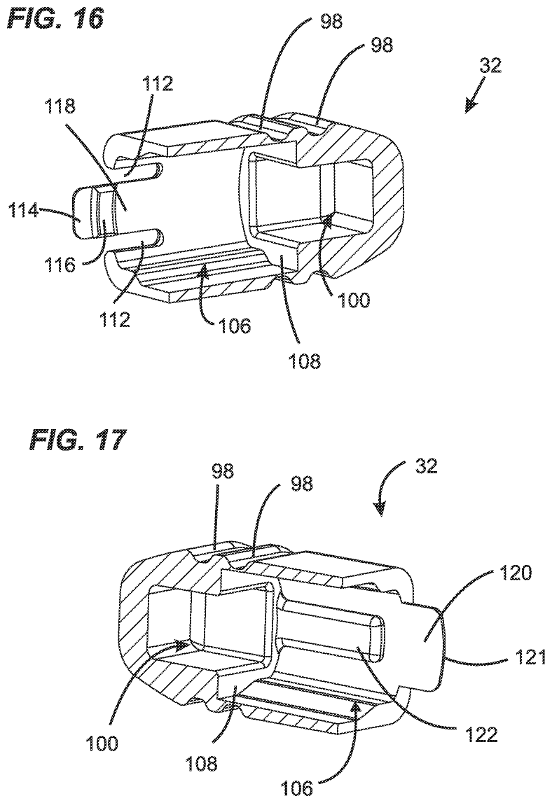

Referring to FIGS. 8-17, the dust cap 32 extends from a front end 64 to a back end 66 along an axis 68. The axis 68 coincides with the axis 12 (FIG. 1) when the dust cap 32 is installed on the subassembly 30. The dust cap 32 extends from a top 69 to a bottom 70 along an axis 72. The axis 72 is parallel to the axis 14 (FIG. 1) when the dust cap 32 is installed on the subassembly 30. The dust cap 32 extends from a left side 74 to a right side 76 along an axis 78. The axis 78 is parallel to the axis 16 (FIG. 1) when the dust cap 32 is installed on the subassembly 30. Due to the proportions of a MPO-type connector, a maximum dimension of the dust cap 32 parallel to the axis 72 can be shorter than a maximum dimension of the dust cap parallel to the axis 78.

The dust cap 32 includes a dust cap body 62. The dust cap 32 defines a dust cap interior 80 and a dust cap exterior 82. The body 62 includes an upper wall 84, a lower wall 86, a left wall 88, and a right wall 90. Each wall 84, 86, 88, 90 includes an inner surface defining the interior 80, and an outer surface at the exterior 82. The dust cap body 62 includes a closed front 92 and an open back end 94. The open back end 94 defines an opening through which the subassembly 30 (FIG. 1) is received to install the dust cap 32 on the subassembly 30. A nose portion 96 of the body 62 tapers (e.g., narrows) forwardly towards the closed end 94. The tapered nose portion 96 can facilitate conveying the dust cap through a duct, for example. In some examples, a pulling eye can be provided in the nose portion for pulling the assembly 10 (FIG. 1) through a duct (e.g., with a rope or a wire). The interior 80 is fully enclosed around the axis 68 by the walls 84, 86, 88 and 90, which can improve protection against contamination of the ends of the optical fibers terminated at the ferrule of the subassembly 30.

The body 62 defines gripping elements 98 that can facilitate gripping of the dust cap 32 (e.g. for installation on or removal from the subassembly 30 (FIG. 1)). The gripping elements 98 are recesses (e.g., elongate recesses) in the outer surfaces of the upper wall 84 and the lower wall 86. Because the gripping elements 98 are recessed (towards the interior 80) relative to the adjacent outer surfaces, the gripping elements 98 do not increase the outer profile of the dust cap 32. For example, the gripping elements 98 do not contribute to any maximum dimension of the dust cap 32 parallel to any of the axes 68, 72, or 78.

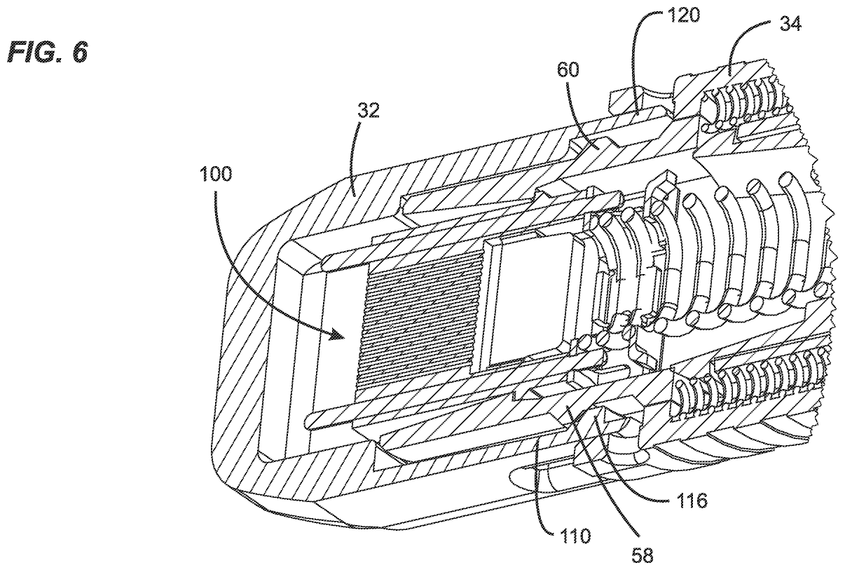

The interior 80 defines a pocket 100 within the nose portion 96. The pocket 100 can, in some examples, receive the ferrule or a portion of the ferrule of the subassembly 30. For a male ferrule, the pocket 100 can receive the alignment pins (FIG. 6).

For improved structural integrity, while minimizing the material and weight of the dust cap 32, and/or to provide an enlarged dimension 104 at the rear interior region 106 of the interior 80 for accommodating large profile portions of the subassembly 30, such as the sleeve 34, the upper wall 86 and the lower wall 88 thicken (as thickened portions 102) towards the side walls 88, 90 and are thinner towards a plane that coincides with the central axis 68. The rear interior region 106 is immediately behind the pocket 100, with the pocket 100 and the region 106 divided by a shoulder 108 that fully surrounds the axis 68 within the interior 80. Extending rearwardly from one of the side walls (in the example shown, the left wall 88), is a latch 110. Above and below the latch 110, the body 62 defines slots 112. The slots 112 facilitate resilient flexing of the latch 110 outwardly (in the direction of the arrow 111) when the dust cap 32 is being installed on or removed from an optical fiber connector. In some examples, slots may be essential to provide adequate flexing capability for the latch. On an inner surface of the latch 110 is a catch 116. The catch 116 has a ramped surface 118 that facilitates riding of the catch 116 forwardly and rearwardly over a shoulder 58 of the subassembly 30 (FIG. 5) when the dust cap 32 is being installed and removed. The latch 110 extends rearwardly beyond the open back end 66 of the body 62 to a rear end 119 of the latch 110.

Extending rearwardly from the other of the side walls (in the example shown, the right wall 90), is a stabilizing projection 120. The stabilizing projection 120 does not include a latch. That is, the projection 120 does not include a future capable of latching to a shoulder 58, 60 of the subassembly 30 (FIG. 5). The stabilizing projection 120 extends rearwardly beyond the open back end 66 of the body 62 to a rear end 121 of the projection 120.

Because the stabilizing projection 120 does not latch to an optical fiber connector, it does not need to flex. Therefore, unlike the latch 110, no slots are provided above or below the projection 120. By reducing the number of slots or other openings in this manner, the cap 32 can provide better protection against ingress of contaminants into the cap interior 80.

The stabilizing projection 120 can serve as a locator that facilitates proper alignment of the dust cap 32 and the subassembly 30 for installing the dust cap thereon. Once installed on the subassembly 30, the projection 120 extends into the subassembly 30 between the inner connector body and the outer connector body, thereby improving stabilization of the cap 32 and inhibiting or preventing unwanted torque or rotation of the dust cap about the axis 12 (FIG. 1), which could undesirably cause the latch 110 to de-latch from the subassembly 30. In some examples, the rear ends 121 and 119 are equidistant from the back end 66. In other examples, one of the rear ends 121, 119 is further back than the other.

In some examples, such as the dust cap 32 shown, the inner surface of the side wall from extends the stabilizing projection 120 includes a reinforcement structure, such as a rib 122. The reinforcement structure can improve the structural integrity of the dust cap 32, inhibiting or preventing undesirable flexion of the stabilizing projection 120, while minimizing the weight and material of the dust cap 32. For example, a fully thickened side wall can require more material than the rib 122.

Due to the structural differences between the left side and the right side of the dust cap 32 as shown and described, the dust cap 32 is asymmetrical about the central vertical plane of the dust cap 32 defined by the intersecting axes 68 and 72. The different structural features that provide the asymmetry can beneficially optimize the amount of force needed to install and remove the dust cap 32, as well as the robustness of the dust cap 32 and its ability to protect the ends of the optical fibers from contamination. For example, because there is only one latch, installation and removal of the dust cap can be performed more easily. As another example, since only one side of the dust cap 32 includes slots, protection of the optical fibers can be improved.

At the back end 66, the cap body 62 includes a rearward facing abutment surface 124 formed by the walls of the cap body.

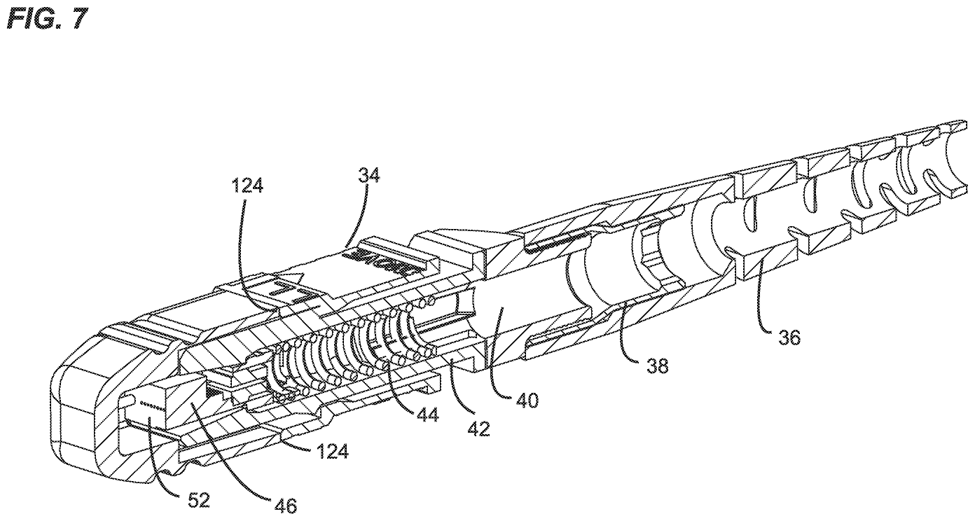

Referring to FIGS. 5-7, when the dust cap 32 is installed on the subassembly 30, the surface 124 abuts a forward facing surface of the sleeve 34. In some examples, the abutment of these surfaces can provide a sealing interface between the dust cap 32 and the subassembly 30 to inhibit or prevent ingress of contaminants into the interior 80 of the dust cap.

When the dust cap 32 is installed on the subassembly 30, the stabilizing projection 120 is received in a space 129 between the outer connector body 34 and the inner connector body 42. In addition, the catch 116 latches the shoulder 58 with the catch 116 positioned immediately behind the shoulder 58. With the sleeve 34 in its forward position (as shown in FIGS. 5-7), the catch 116 is sandwiched between the sleeve 34 and the inner connector body 42, providing a robust coupling of the dust cap 32 to the subassembly 30. For example, it can be impossible for the catch 116 to forwardly clear the shoulder 58 due to interference between the latch 110 and the sleeve 34. In these examples, the sleeve 34 must be pulled back in the direction of the arrow 130 against the biasing force of the springs 54 in order for the catch 116 to be able to ride over and forwardly clear the shoulder 58 to remove the dust cap 32 from the subassembly 30.

In other examples, the latch can be configured to be sufficiently thin such that there is sufficient clearance between the latch and the interior surface of the sleeve 34 even when the sleeve 34 is in the forward position, for the catch to forwardly clear the shoulder 58 to remove the dust cap from the subassembly. Thus, in some examples, the sleeve 34 must be slid rearwards to remove the dust cap, while in other examples, the dust cap can be removed without sliding the sleeve 34 and with the sleeve 34 remaining in its forward position.

The dust cap 32 can be rotated 180 degrees about the axis 12 (FIG. 1) and used the exact same way, with the latch 110 latching to the shoulder 60 and the stabilizing projection 120 positioned between the shoulder 58 and the sleeve 34 on the other side.

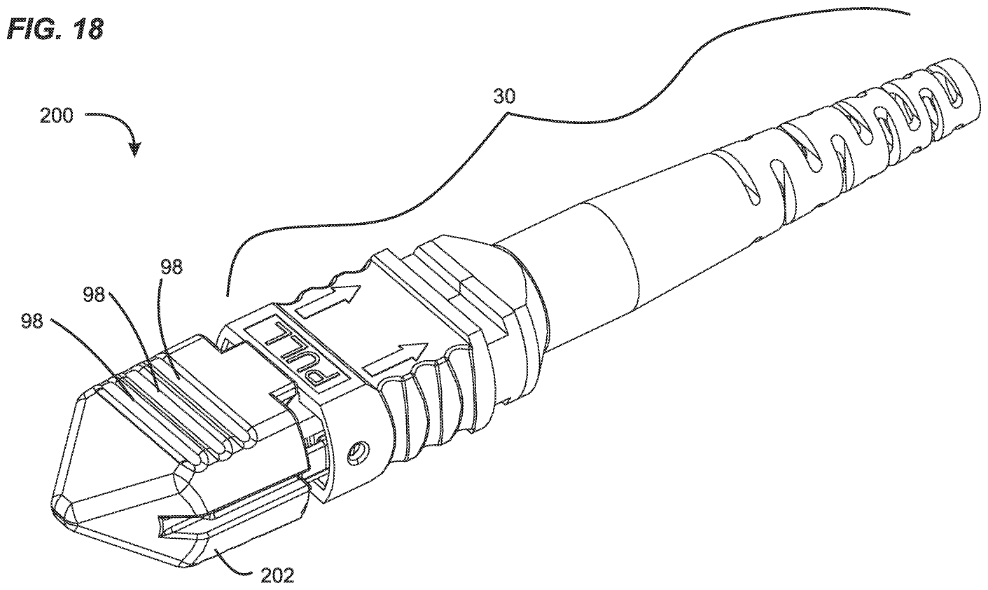

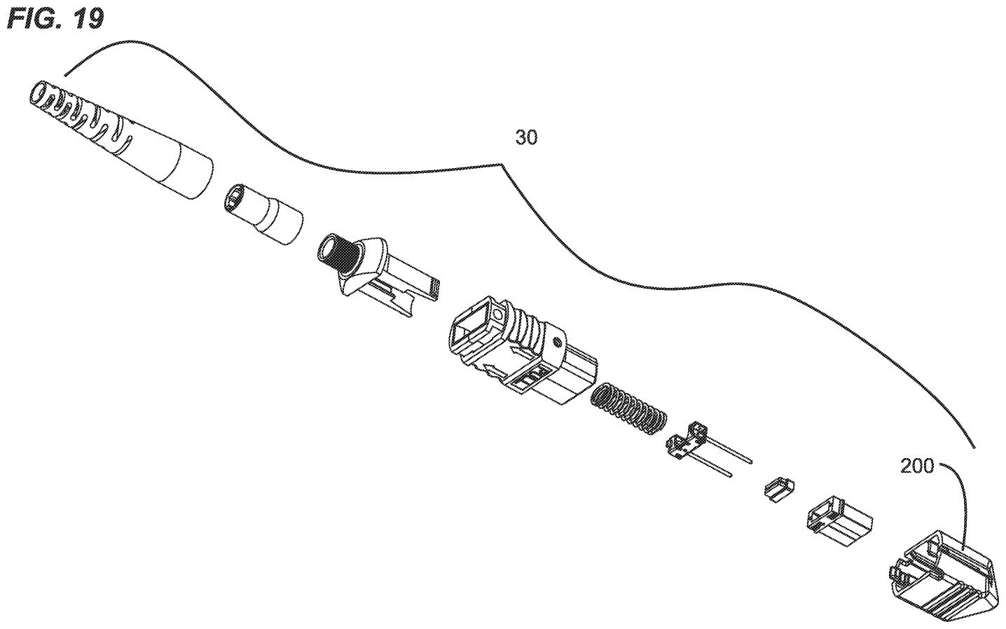

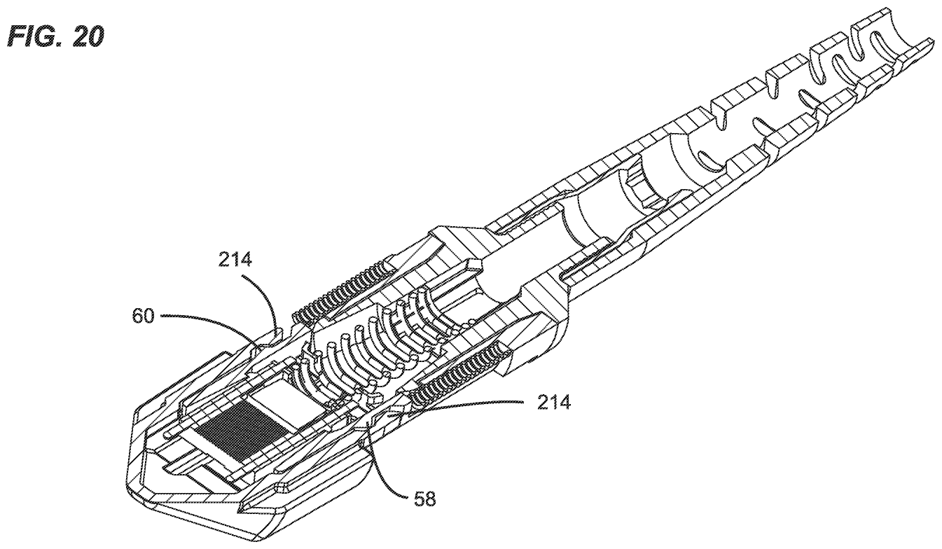

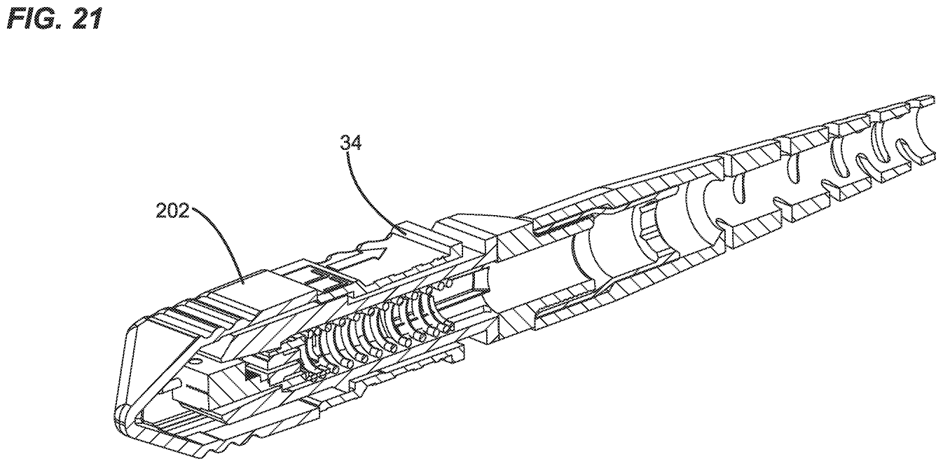

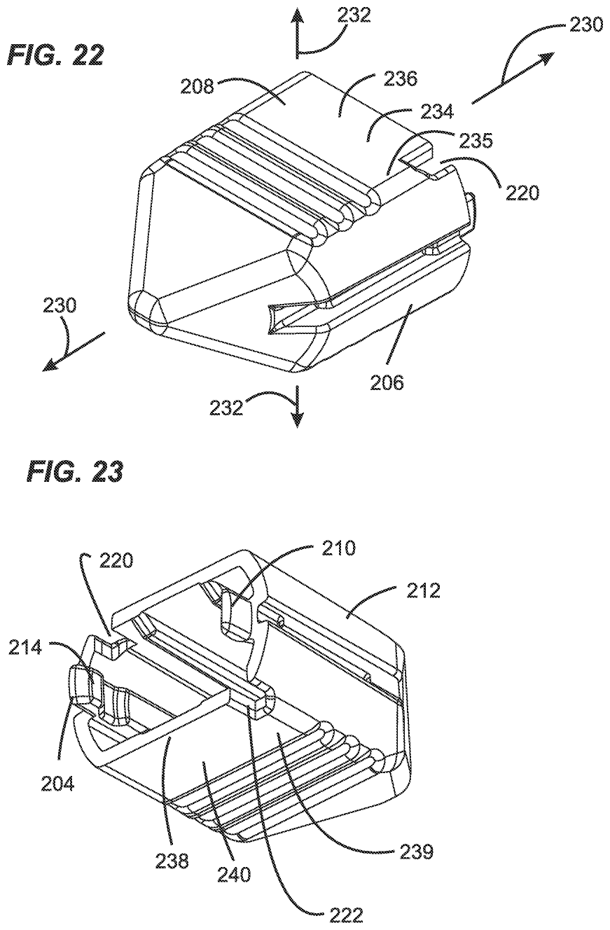

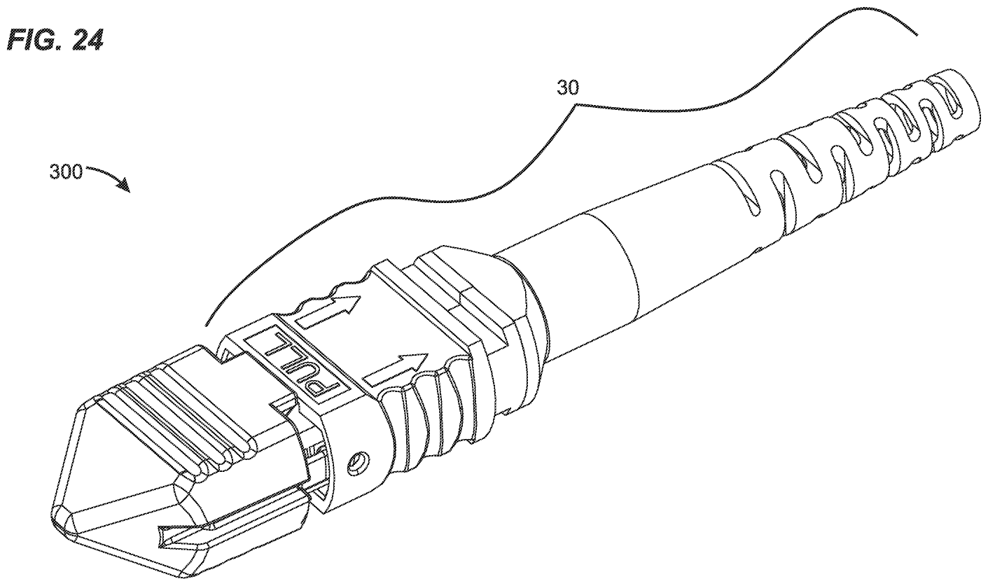

Referring to FIGS. 18-23, a further example assembly 200 will be described. The assembly 200 includes the subassembly 30 and a dust cap 202 that can mount thereto. The dust cap 202 serves the same function as the dust cap 32. In the interest of brevity, the following description will focus largely on features of the dust cap 202 that differ from the dust cap 32.

The dust cap 202 includes two latches, a latch 204 extending rearwardly from the left side wall 206 of the dust cap body 208, and a latch 210 extending rearwardly from the right side wall 212 of the dust cap body 208. Each latch 204, 210 includes a catch 214 that latches to a shoulder 58, 60 of the subassembly 30 when the dust cap 202 is mounted thereto.

To provide adequate outward flexion of the latches 204, 210 to allow the catches 214 to rearwardly and forwardly clear the shoulders 58, 60 when installing and removing the cap (e.g., with the sleeve 34 pulled back), the cap body 208 includes notches 220 and 222 extending forwardly from the rear end of the cap body at each of the top wall and the bottom wall. The notch 220 is provided at the back end of the body 208 and is defined by the upper wall and the left side wall of the body 208. The notch 222 is provided at the back end of the body 208 and is defined by the lower wall and the right side wall of the body 208. The presence of the notches 220, 222 improves the resilient flexibility of the latches 204, 210, to allow installation and removal of the dust cap.

Each latch 204, 210 includes exactly one flexion enhancing notch 220 or slot. Because there are only two notches provided (and not. e.g., two notches for each latch), protection against ingress of contaminants into the cap interior can be improved.

In addition, because one of the notches is at the top of the dust cap and the other of the notches as at the bottom of the dust cap, the structural integrity of the dust cap can be improved, and/or manufacturing capability (e.g., by molding) of the dust cap can be improved.

Due to the placement of the notches, the dust cap 202 is asymmetrical about the central vertical plane of the dust cap 202 defined by the front to back central axis 230 and the perpendicular up-down axis 232 that intersects the axis 230.

Due to the presence of the notches 220, 222, a first portion 234 of the top wall 236 of the cap body 208 extends further back than a second portion 235 of the top wall 236. In addition, a first portion 238 of the bottom wall 240 extends further back than a second portion 239 of the bottom wall 240. The first portion 234 of the top wall 236 and the first portion 238 of the bottom wall 240 coincide with the central vertical plane defined by the axis 230 and 232.

As the terms are used herein, each slot and each notch can be alternatively referred to as a material void.

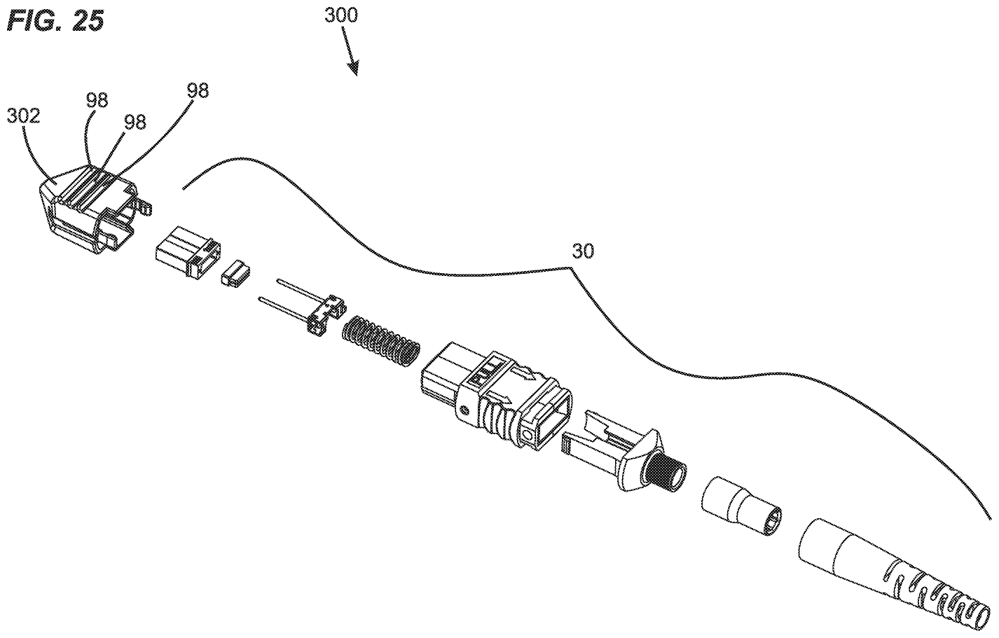

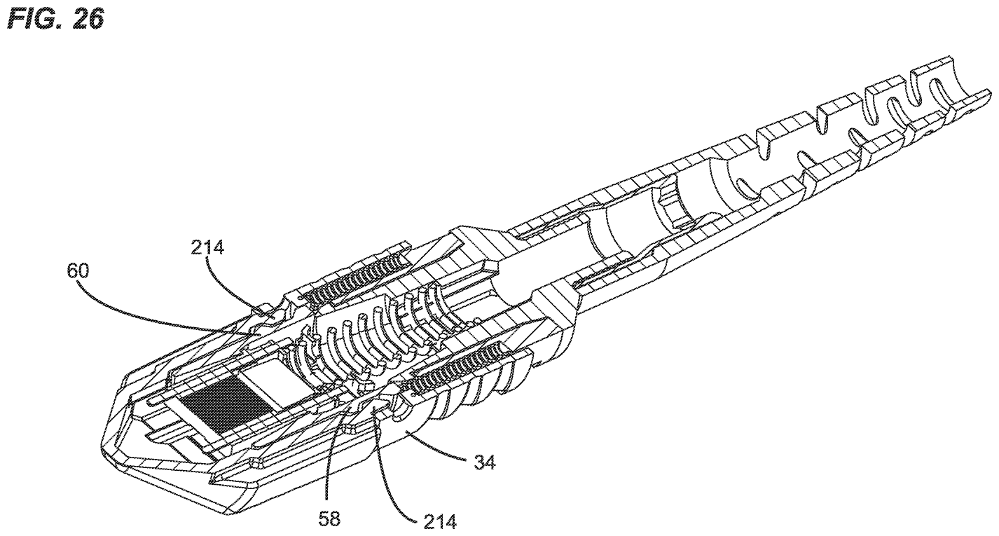

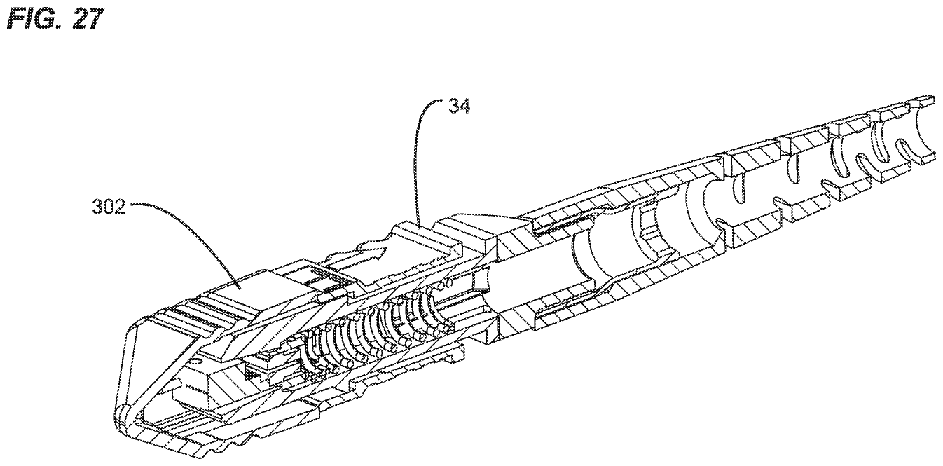

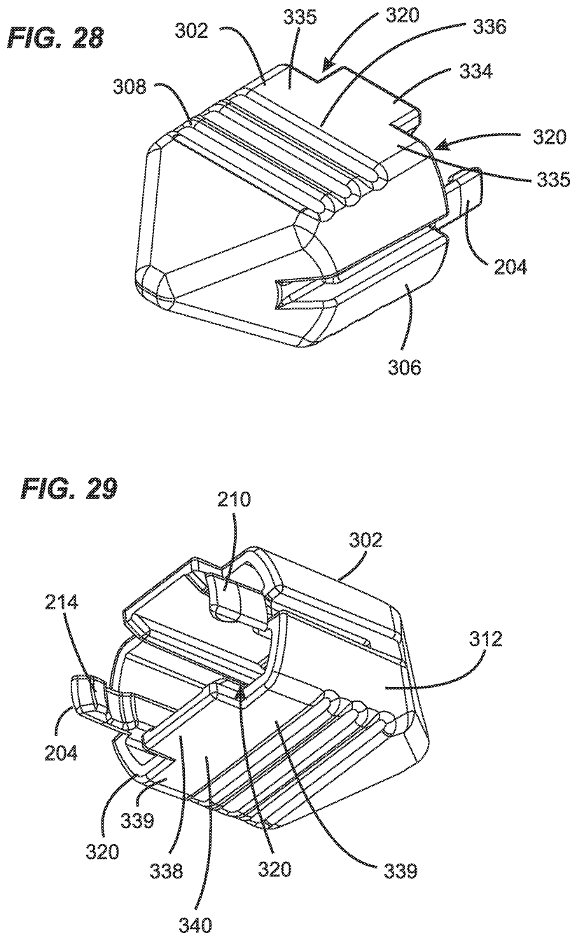

Referring to FIGS. 24-29, a further example assembly 300 will be described. The assembly 300 includes the subassembly 30 and a dust cap 302 that can mount thereto. The dust cap 302 serves the same function as the dust cap 32 and the dust cap 202. In the interest of brevity, the following description will focus largely on features of the dust cap 302 that differ from the dust caps 32 and 202.

The dust cap 302 includes two latches, a latch 204 extending rearwardly from the left side wall 306 of the dust cap body 308, and a latch 210 extending rearwardly from the right side wall 312 of the dust cap body 308. Each latch 204, 210 includes a catch 214 that latches to a shoulder 58, 60 of the subassembly 30 when the dust cap 302 is mounted thereto.

To provide flexion capability of the latches 204, 210 to allow the catches 214 to rearwardly and forwardly clear the shoulders 58, 60 when installing and removing the cap (e.g., with the sleeve 34 pulled back), the cap body 308 includes material voids 320. The material voids 320 are provided at the back end of the body 308 and defined by right and left portions of the upper wall, and by right and left portions of the lower wall of the body 308. The presence of the material voids 320 improves the resilient flexibility of the latches 204, 210, to allow installation and removal of the dust cap.

Due to the presence of the material voids 320, a first portion 334 of the top wall 336 of the cap body 308 extends further back than second portions 335 of the top wall 336 at either side of the first portion 334. In addition, a first portion 338 of the bottom wall 340 extends further back than second portions 339 of the bottom wall 340 at either side of the first portion 338. The first portions of the top wall and the bottom wall coincide with the central vertical plane defined by the dust cap 302.

The portions 334 and 338 abut the sleeve 34 when the dust cap 302 is installed on the subassembly 30.

Various modifications and alterations of this disclosure will become apparent to those skilled in the art without departing from the scope and spirit of this disclosure, and it should be understood that the scope of this disclosure is not to be unduly limited to the illustrated embodiments set forth herein.

What is claimed is:

1. A dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap comprising:
a cap body defining a cap interior and a cap exterior, the cap body having an open back end and a closed front end, the cap body being configured to receive a portion of the connector in the cap interior through the open back end; and
a latch at at least one of the left side and the right side of the dust cap,
wherein the latch is configured to lockingly engage the connector when the connector is received in the cap interior, and
wherein the dust cap is asymmetrical about a plane defined by the first axis and the second axis.

2. The dust cap of claim 1, wherein the dust cap does not include a latch at the other of the left side and the right side.

3. The dust cap of claim 1, wherein the dust cap includes a latch at the other of the left side and the right side.

4. The dust cap of claim 3, wherein each latch is associated with exactly one material void in the cap body configured to facilitate flexing of the latch.

5. The dust cap of claim 4,
wherein the material void associated with the one of the latches is in an upper wall of the cap body, and
wherein the material void associated with the other of the latches is in a lower wall of the cap body.

6. The dust cap of claim 1 wherein the dust cap includes a stabilizing projection at the other of the left side and the right side, the stabilizing projection being configured to be received in a portion of the connector when the dust cap is installed on the connector.

7. The dust cap of any of claims 1-6, wherein a maximum dimension of the dust cap parallel to the second axis is shorter than a maximum dimension of the dust cap parallel to the third axis.

8. The dust cap of any of claims 1-7, wherein the cap body tapers towards the closed front end.

9. The dust cap of any of claims 1-8, wherein the cap body defines a finger grip recessed from an exterior surface of the cap body.

10. The dust cap of claim 9, wherein no portion of the finger grip contributes to a maximum dimension of the dust cap along any of the first axis, the second axis or the third axis.

11. A dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap comprising:
a cap body defining a cap interior and a cap exterior, the cap body having an open back end and a closed front end, the cap body being configured to receive a portion of the connector in the cap interior through the open back end, the cap body including a top wall and a bottom wall; and
a latch at at least one of the left side and the right side of the dust cap,
wherein a first portion of the top wall extends further back than a second portion of the top wall.

12. The dust cap of claim 11, wherein a first portion of the bottom wall extends further back than a second portion of the bottom wall.

13. The dust cap of any of claims 11-12, wherein the first portion of the bottom wall coincides with a plane defined by the first axis and the second axis.

14. The dust cap of any of claims 11-13, wherein the first portion of the top wall coincides with a plane defined by the first axis and the second axis.

15. The dust cap of any of claims 11-13, wherein the dust cap is asymmetrical about the plane defined by the first axis and the second axis.

16. The dust cap of any of claims 11-13, wherein the dust cap is symmetrical about the plane defined by the first axis and the second axis.

17. The dust cap of any of claims 11-16, wherein the top wall defines a material void extending forward from a back end of the first portion of the top wall.

18. The dust cap of claim 17, wherein the material void is on only one of a left side and a right side of the top wall.

19. The dust cap of claim 17, wherein the top wall defines another material void extending forward from the back end of the first portion of the top wall, the material void and the another material void being on right and left sides, respectively, of the first portion of the top wall.

20. The dust cap of any of claims 12-13,
wherein the top wall defines a top wall material void extending forward from a back end of the first portion of the top wall; and
wherein the bottom wall defines a bottom wall material void extending forward from the back end of the first portion of the bottom wall.

21. The dust cap of claim 20,
wherein the top wall material void is on only a left side of the top wall; and
wherein the bottom wall material void is on only a right side of the bottom wall.

22. The dust cap of claim 20,
wherein the top wall defines another top wall material void extending forward from the back end of the first portion of the top wall, the top wall material void and the another top wall material void being on right and left sides, respectively, of the first portion of the top wall; and
wherein the bottom wall defines another bottom wall material void extending forward from the back end of the first portion of the bottom wall, the bottom wall material void and the another bottom wall material void being on right and left sides, respectively, of the first portion of the bottom wall.

23. A dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap comprising:
a cap body defining a cap interior and a cap exterior, the cap body having an open back end and a closed front end, the cap body being configured to receive a portion of the connector in the cap interior through the open back end,
wherein the dust cap includes only one latch configured to latch the dust cap to the optical fiber connector when the optical fiber connector is received in the cap interior.

24. The dust cap of claim 23, wherein the latch extends rearward from the back end of the cap body.

25. The dust cap of claim 24, wherein the latch is positioned at the left side or at the right side of the dust cap.

26. The dust cap of claim 25, wherein the dust cap includes a stabilizing projection at the other of the left side and the right side, the stabilizing projection being configured to be received in a portion of the connector when the dust cap is installed on the connector.

27. The dust cap of any of claims 23-26, further comprising a slot extending forward from the rear end of the cap body above or below the latch and at the same side of the dust cap as the latch.

28. The dust cap of any of claims 23-26, further comprising slots extending forward from the rear end of the cap body above and below the latch, respectively, and at the same side of the dust cap as the latch.

29. The dust cap of any of claims 23-28, wherein a maximum dimension of the dust cap parallel to the second axis is shorter than a maximum dimension of the dust cap parallel to the third axis.

30. The dust cap of any of claims 23-29, wherein the cap body tapers towards the closed front end.

31. The dust cap of any of claims 23-30, wherein the cap body defines a finger grip recessed from an exterior surface of the cap body.

32. The dust cap of claim 31, wherein no portion of the finger grip contributes to a maximum dimension of the dust cap along any of the first axis, the second axis or the third axis.

33. A dust cap for capping an end of an optical fiber connector, the dust cap extending from a front end to a back end along a central first axis, the dust cap extending from a top to a bottom along a second axis, the dust cap extending from a left side to a right side along a third axis, the first axis, the second axis and the third axis being mutually perpendicular to one another, the dust cap comprising:
a cap body defining a cap interior and a cap exterior, the cap body having an open back end and a closed front end, the cap body being configured to receive a portion of the connector in the cap interior through the open back end; and
a latch at each of the left side and the right side of the dust cap,
wherein each latch is configured to lockingly engage the connector when the connector is received in the cap interior, and
wherein each latch is associated with exactly one material void in the cap body configured to facilitate flexing of the latch.

34. An assembly, comprising:
a fiber optic connector subassembly; and
the dust cap of any of claims 1-33 installed on the subassembly, such that a portion of the subassembly is received in the cap interior, and such that the dust cap is latched to the subassembly.

35. The assembly of claim 34, wherein the subassembly includes:
a ferrule;
an optical fiber terminated at the ferrule;
an inner connector body that receives the ferrule and to which the dust cap is latched; and
and an outer connector body that slides relative to the inner connector body parallel to the first axis.

36. The assembly of claim 35, further comprising a spring positioned in the inner connector body and biasing the ferrule forwards.

37. The assembly of any of claims 35-36, comprising a plurality of fibers terminated at the ferrule.

38. The assembly of claim 36, further comprising a spring seat such that the spring is compressed between the spring seat and the ferrule.

39. The assembly of claim 38, further comprising a boot mounted at a rear end of the spring seat and extending rearwardly from the inner connector body.

40. An assembly, comprising:
a fiber optic connector subassembly, including:
a ferrule;
optical fibers terminated at the ferrule;
an inner connector body that receives the ferrule;
an outer connector body that slides relative to the inner body parallel to a first axis;
a spring seat positioned in the inner connector body; and
a spring positioned in the inner connector body, the spring being compressed between the spring seat and the ferrule and biasing the ferrule along the first axis; and
a dust cap installed on the subassembly, the dust cap extending from a front end to a back end along the first axis, the dust cap extending from a top to a bottom along a second axis, the dust cap extending from a left side to a right side along a third axis, the first axis, the second axis and the third axis being mutually perpendicular to one another, the dust cap including:
a cap body defining a cap interior and a cap exterior, the cap body having an open back end and a closed front end, the cap body receiving a portion of the inner connector body in the cap interior, and
a latch at at least one of the left side and the right side of the dust cap, the latch latching to a shoulder defined by the inner connector body,
wherein the dust cap is asymmetrical about a plane defined by the first axis and the second axis.

41. The assembly of claim 40, further comprising a boot mounted at a rear end of the spring seat and extending rearwardly from the inner connector body.

42. A method, comprising:
removing the dust cap from the assembly of any of claims 40-41 by sliding the outer connector housing in rearwardly and, while the outer housing is slid rearward, pulling the dust cap forward.

43. A method, comprising:
removing the dust cap from the assembly of any of claims 40-41 by pulling the dust cap forward without moving the outer connector body from a front-most position of the outer connector body.

44. The dust cap of any of claims 1-33, wherein the dust cap is configured to latch to a MPO-type optical fiber connector.
